(19) United States
(12) Patent Application Publication
(10) Pub. No.: US 2026/0029683 A1
(43) Pub. Date: Jan. 29, 2026

(54) OPTICAL MODULATOR, VISIBLE LIGHT SOURCE MODULE, OPTICAL ENGINE, IMAGE DISPLAY DEVICE, XR GLASSES, AND METHOD FOR CONTROLLING OPTICAL MODULATOR

(71) Applicant: TDK CORPORATION, Tokyo (JP)

(72) Inventors: Shigeru MIEDA, Tokyo (JP); Yasuhiro TAKAGI, Tokyo (JP); Jiro YOSHINARI, Tokyo (JP)

(73) Assignee: TDK CORPORATION, Tokyo (JP)

(21) Appl. No.: 19/276,584

(22) Filed: Jul. 22, 2025

(30) Foreign Application Priority Data
Jul. 25, 2024 (JP) 2024-120395

(51) Int. Cl. G02F 1/21; G02B 27/01; G02F 1/01; G02F 1/035

(52) U.S. Cl. CPC G02F 1/212; G02B 27/0172; G02F 1/0123; G02F 1/035; G02B 2027/0112; G02F 2202/20

(57) ABSTRACT

The optical modulator of the present disclosure includes Mach-Zehnder optical modulation units; a power supply for applying a pixel voltage to the Mach-Zehnder optical modulation units; a control unit controlling the power supply, wherein the control unit includes an integrating circuit calculating an integrated value of the pixel voltages applied to the Mach-Zehnder optical modulation units, the control unit controls the power supply to continuously apply the pixel voltage at applied voltage width to the Mach-Zehnder optical modulation units; the control unit controlling the power supply to apply a shift voltage that is an even multiple of a half-wavelength voltage to the Mach-Zehnder optical modulation units when an integrated value of the pixel voltage integrated by the integrating circuit reaches a value for any of the plurality of Mach-Zehnder optical modulation units.

### CROSS-REFERENCES TO RELATED APPLICATIONS

This application relies for priority upon Japanese Patent Application No. 2024-120395 filed on Jul. 25, 2024, the entire content of which is hereby incorporated herein by reference for all purposes as if fully set forth herein.

### BACKGROUND

The present disclosure relates to an optical modulator, a visible light source module, an optical engine, an image display device, XR glasses, and a method for controlling an optical modulator.

XR glasses such as AR (Augmented Reality) glasses and VR (Virtual Reality) glasses are expected to be small wearable devices. The key to the widespread use of XR glasses is to miniaturize them so that each function fits into the size of a normal pair of glasses. In this situation, Mach-Zehnder optical modulators using lithium niobate films are expected as a promising candidate (for example, see Patent Documents 1 and 2).

It is known that a phenomenon called DC drift occurs in Mach-Zehnder optical modulators using lithium niobate films, in which the bias voltage-optical output characteristic shifts over time in the bias voltage direction. Therefore, even if a constant bias voltage is applied to a Mach-Zehnder optical modulator, the optical output changes over time due to DC drift, making it difficult to obtain a constant optical output over the long term.

Patent Document 1 discloses an disclosure that follows changes in the operating point voltage caused by DC drift by performing feedback control on the bias voltage based on the average intensity of the output light. This disclosure is a means to solve the limitation of product life caused by the range in which the operating point voltage can be followed is limited by the withstand voltage of the modulator or IC. In addition, this disclosure is a means to control the DC drift while keeping the operating point voltage within a specified range by utilizing the property that the direction of the DC drift is correlated with the polarity of the applied voltage and changing the bias voltage to a voltage of the opposite polarity when the operating point voltage range is exceeded.

### PRIOR ART DOCUMENTS

### Patent Documents

Patent Document 1: JP Patent No. 7306347B
Patent Document 2: JP Patent No. 7400661B
Patent Document 3: JP Patent No. 2518138B

### SUMMARY

However, the disclosure in Patent Document 1 requires an operating point voltage detection means for detecting the operating point voltage, which is the voltage at half the maximum optical output. Also, it requires input of two reference voltages for calculating the operating point and comparison, which complicates control and implementation.

When a Mach-Zehnder optical modulator using a lithium niobate film is applied to XR glass, the color corresponding to the drive voltage cannot be stably output continuously due to the change over time of the optical output caused by DC drift, so it is necessary to suppress or compensate for the DC drift.

The present disclosure has been made in consideration of the above-mentioned problems, and aims to provide an optical modulator, a visible light source module, an optical engine, an image display device, XR glasses, and a control method for an optical modulator that are capable of suppressing or compensating for DC drift.

In order to solve the above problems, the present disclosure provides the following means.

A first aspect of the present disclosure is an optical modulator for an image display device that displays an image on an image display surface by scanning a combined light of a plurality of color laser beams pixel by pixel at a predetermined time step, the optical modulator including: a plurality of Mach-Zehnder optical modulation units, each of which has a Mach-Zehnder optical waveguide formed of a ridge formed in a ferroelectric thin film represented by the chemical formula ABX₃ and an electrode for applying an electric field to the Mach-Zehnder optical waveguide; a power supply for applying a pixel voltage to each of the plurality of Mach-Zehnder optical modulation units independently; a control unit configured to control the power supply, wherein the control unit includes an integrating circuit capable of calculating an integrated value of the pixel voltages applied to each of the plurality of Mach-Zehnder optical modulation units, the control unit is configured to control the power supply so as to continuously apply the pixel voltage at a predetermined applied voltage width to each of the plurality of Mach-Zehnder optical modulation units independently; the control unit is configured to further control the power supply to apply a shift voltage that is an even multiple of a half-wavelength voltage to each of the plurality of Mach-Zehnder optical modulation units at a timing when an integrated value of the pixel voltage integrated by the integrating circuit reaches a predetermined value for any of the plurality of Mach-Zehnder optical modulation units.

A second aspect of the present disclosure is an optical modulator for an image display device that displays an image on an image display surface by scanning a combined light of a plurality of color laser beams pixel by pixel at a predetermined time step, a plurality of Mach-Zehnder optical modulation units, each of which has a Mach-Zehnder optical waveguide formed of a ridge formed in a ferroelectric thin film represented by the chemical formula ABX₃ and an electrode for applying an electric field to the Mach-Zehnder optical waveguide; a power supply for applying a pixel voltage to each of the plurality of Mach-Zehnder optical modulation units independently; a control unit configured to control the power supply, wherein the control unit includes an integrating circuit capable of calculating an integrated value of the pixel voltages applied to each of the plurality of Mach-Zehnder optical modulation units, the control unit is configured to control the power supply so as to continuously apply the pixel voltage at a predetermined applied voltage width to each of the plurality of Mach-Zehnder optical modulation units independently; the control unit is configured to further control the power supply to apply a shift voltage that shifts an applied voltage width to a position symmetrical with respect to an extreme value of optical output in a modulation curve of each of the plurality of Mach-Zehnder optical modulation units to each of the plurality of Mach-Zehnder optical modulation units at a timing when an integrated value of the pixel voltage integrated by the integrating circuit reaches a predetermined value for any of the plurality of Mach-Zehnder optical modulation units.

A third aspect of the present disclosure is the optical modulator of the first or second aspect, wherein the Mach-Zehnder optical waveguide is made of C-axis oriented lithium niobate.

A fourth aspect of the present disclosure is the optical modulator according to any one of the first to third aspects, wherein the Mach-Zehnder optical waveguide is made of X-cut lithium niobate.

A fifth aspect of the present disclosure is a visible light source module including: the optical modulator according to any one of the first to fourth aspects; and a plurality of visible light laser light sources each emitting a plurality of colored laser beams.

A sixth aspect of the present disclosure is an optical engine including: the visible light source module according to the fifth aspect; and an optical scanning mirror configured to reflect the light emitted from the visible light source module at a different angle so as to display an image.

A seventh aspect of the present disclosure is an image display device including the optical engine according to the sixth aspect.

An eighth aspect of the present disclosure is the image display device according to the seventh aspect, wherein the image display device is an XR glass.

A ninth aspect of the present disclosure is a method for controlling an optical modulator for an image display device that displays an image on an image display surface by scanning a combined light of a plurality of colored laser beams pixel by pixel at a predetermined time step, the method including the steps of: using an optical modulator including a plurality of Mach-Zehnder optical modulation units, a power supply for applying a pixel voltage to each of the plurality of Mach-Zehnder optical modulation units independently, and a control unit that is configured to control the power supply and includes an integrating circuit capable of calculating an integrated value of the pixel voltages applied to each of the plurality of Mach-Zehnder optical modulation units, controlling the power supply by the controlling unit, so as to continuously apply the pixel voltage at a predetermined applied voltage width to each of the plurality of Mach-Zehnder optical modulation units independently, and to further control the power supply to apply a shift voltage that is an even multiple of a half-wavelength voltage to each of the plurality of Mach-Zehnder optical modulation units at a timing when an integrated value of the pixel voltage integrated by the integrating circuit reaches a predetermined value for any of the plurality of Mach-Zehnder optical modulation units.

A tenth aspect of the present disclosure is a method for controlling an optical modulator for an image display device that displays an image on an image display surface by scanning a combined light of a plurality of colored laser beams pixel by pixel at a predetermined time step, the method including the steps of: using an optical modulator including a plurality of Mach-Zehnder optical modulation units, a power supply for applying a pixel voltage to each of the plurality of Mach-Zehnder optical modulation units independently, and a control unit that is configured to control the power supply and includes an integrating circuit capable of calculating an integrated value of the pixel voltages applied to each of the plurality of Mach-Zehnder optical modulation units, controlling the power supply by the controlling unit, so as to continuously apply the pixel voltage at a predetermined applied voltage width to each of the plurality of Mach-Zehnder optical modulation units independently, and to further control the power supply to apply a shift voltage that shifts an applied voltage width to a position symmetrical with respect to an extreme value of optical output in a modulation curve of each of the plurality of Mach-Zehnder optical modulation units to each of the plurality of Mach-Zehnder optical modulation units at a timing when an integrated value of the pixel voltage integrated by the integrating circuit reaches a predetermined value for any of the plurality of Mach-Zehnder optical modulation units.

According to the optical modulator of the present disclosure, it is possible to provide an optical modulator capable of suppressing or compensating for DC drift.

### BRIEF DESCRIPTION OF THE DRAWINGS

FIG. 1 is a conceptual diagram of a Mach-Zehnder optical modulator.

FIG. 2 is a diagram showing the basic configuration of an optical modulator.

FIG. 3 is a diagram for explaining a case where the modulation curve of an LN optical modulator shifts to the positive side due to DC drift caused by a positive bias voltage.

FIG. 4 is a schematic diagram of an image display device including a light modulator according to the present disclosure.

FIG. 5A is a conceptual diagram showing a drawing area on an image display surface, illustrating an example of a scanning method.

FIG. 5B is a conceptual diagram showing a pattern of pixel voltages (pixel signals) applied to one of the RGB Mach-Zehnder light-modulating units, with the horizontal axis representing time and the vertical axis representing a pixel voltage (pixel signal) applied to one of the RGB Mach-Zehnder light-modulating units.

FIG. 6 conceptually illustrates an arrangement of three consecutive pixels among the pixels that make up an image.

FIG. 7 conceptually illustrates combinations of pixel voltages (pixel signals) for each of RGB in one column of 1280 pixels when the number of pixels is “1280×720.”

FIG. 8A is a conceptual diagram showing a drawing area on an image display surface, illustrating an example of a scanning method.

FIG. 8B conceptually illustrates control for shifting the range of applied voltage width Vpp of pixel voltages by applying a shift voltage in the scanning method illustrated in FIG. 8A.

FIG. 8C is a diagram showing the application patterns of pixel voltages over time in the first scan [1], the second scan [2], and the third scan [3] shown in FIG. 8A.

FIG. 8D is a diagram showing, over time, control for shifting the range of the applied voltage width Vpp of the pixel voltage by applying a shift voltage at the timing when the integrated value of the pixel voltage reaches a predetermined value. Figure

FIG. 9 is a flowchart showing an example of control executed by a control unit on a light modulator during image formation.

FIG. 10A is a schematic plan view of an optical modulator according to the present disclosure having three Mach-Zehnder optical waveguides 11 as shown in FIG. 2.

FIG. 10B is a schematic plan view of another example of an optical modulator according to the present disclosure, which is the same as the optical modulator shown in FIG. 10A except that it has an optical multiplexer.

FIG. 11 is a schematic cross-sectional view of the optical modulator shown in FIGS. 10A and 10B taken along line AA′.

FIG. 12 is a schematic plan view of a light source module according to the present disclosure.

FIG. 13 is a schematic cross-sectional view of a part of the light source module shown in FIG. 12 cut along the XZ plane, depicting only a part near the joint.

FIG. 14 is a conceptual diagram for explaining an example of XR glasses of the present disclosure.

FIG. 15 is a conceptual diagram showing how an image is directly projected onto the retina by laser light emitted from a light source module in the XR glasses shown in FIG. 14.

### DETAILED DESCRIPTION

The present disclosure will be described in detail below with reference to the drawings as appropriate. The drawings used in the following description may show characteristic parts in an enlarged scale for the sake of convenience in order to make the characteristics easier to understand, and the dimensional ratios of each component may differ from the actual ones. The materials, dimensions, etc. exemplified in the following description are merely examples, and the present disclosure is not limited thereto. They may be modified as appropriate within the scope of the effects of the present disclosure.

### Optical Modulator

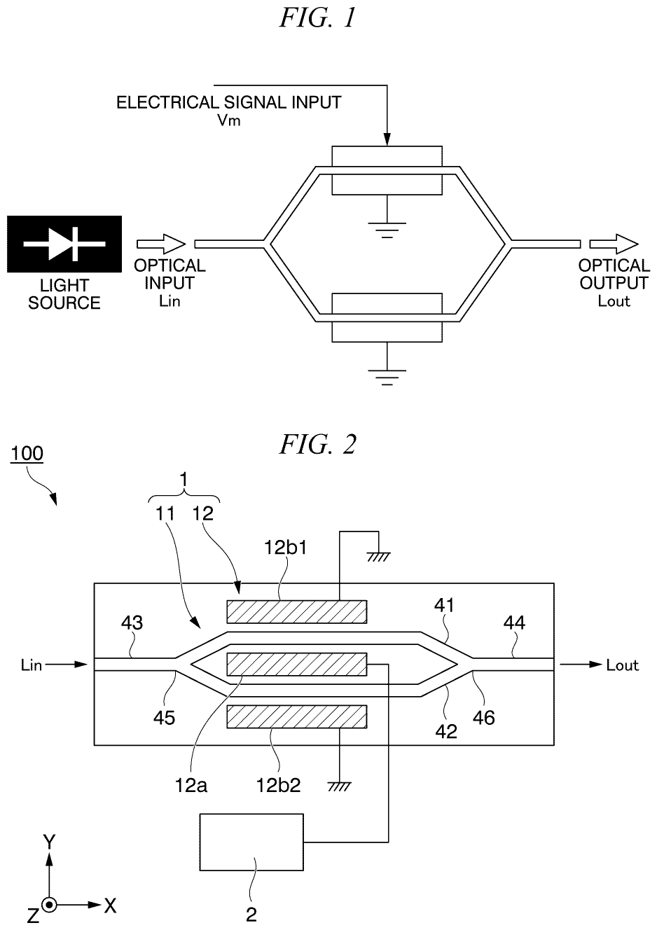

FIG. 1 shows a conceptual diagram of a Mach-Zehnder optical modulator. The optical modulator according to the present disclosure is a Mach-Zehnder optical modulator (hereinafter, sometimes referred to as an “optical modulator” or an “LN optical modulator”). The optical modulator includes a Mach-Zehnder optical waveguide and an electrode for applying a modulation signal (drive signal) Vₘ.

In an operating LN optical modulator, in addition to a high-frequency signal V_{REF} for modulation, a direct current bias (DC bias) voltage V_{DC} for adjusting the modulation state of the optical output is applied to the electrodes. In this case, the bias voltage V_{DC} is the DC component of the modulation signal Vₘ.

Input light Lᵢₙ supplied from a light source is intensity-modulated by an LN optical modulator, and intensity-modulated output light Lₒᵤₜ is output.

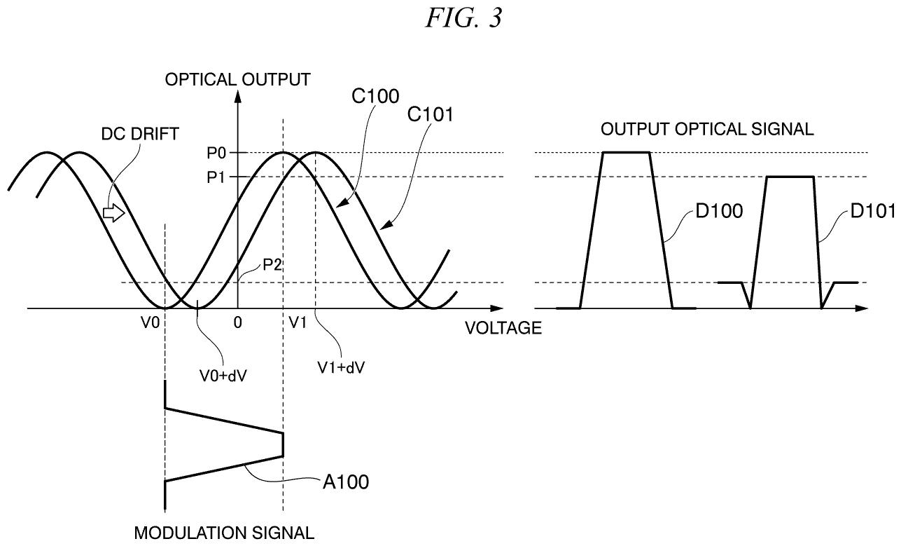

FIG. 2 shows the basic configuration of an optical modulator.

The optical modulator 100 shown in FIG. 2 has a Mach-Zehnder optical modulation section 1 having a Mach-Zehnder optical waveguide 11 and a modulation electrode (signal electrode) 12 for applying a modulation signal Vₘ to the Mach-Zehnder optical waveguide 11, and a control section 2 for supplying the modulation signal Vₘ to the modulation electrode 12.

In FIG. 2, the X direction is a direction perpendicular to a side surface on which an input port through which input light is input is disposed, the Y direction is a direction perpendicular to the X direction, and the Z direction is a direction perpendicular to a plane formed by the X direction and the Y direction.

In the optical modulator according to the present disclosure, the control unit includes a high frequency signal pulse generation control circuit that controls application of pixel voltage, and a DC bias control circuit, and may include an optical switch control circuit that controls on/off of an optical switch described below.

The Mach-Zehnder optical modulation section 1 modulates the intensity of output light in response to a modulation signal Vₘ supplied to a modulation electrode 12. The Mach-Zehnder optical waveguide 11 branches one input waveguide (optical waveguide) 43 at a Y branch 45 into two ridge type optical waveguides, a first ridge type optical waveguide 41 and a second ridge type optical waveguide 42, and is again coupled to one output waveguide 44 at a Y branch 46. The modulation electrode 12 comprises a signal electrode 12a formed between the first ridge type optical waveguide 41 and the second ridge type optical waveguide 42, and counter electrodes 12b1 and 12b2 provided to sandwich the first ridge type optical waveguide 41 and the second ridge type optical waveguide 42.

In the optical modulator according to the present disclosure, the modulating electrode for the Mach-Zehnder optical waveguide can be arranged in a known manner. Although FIG. 2 shows an example in which the modulating electrode is arranged on the side of the Mach-Zehnder optical waveguide, a configuration in which the modulating electrode is arranged above the Mach-Zehnder optical waveguide may also be used.

In the configuration diagram shown in FIG. 2, only the modulation electrode 12 is provided for the high frequency signal V_{REF} and the DC bias voltage V_{DC}, but a configuration in which separate electrodes are provided for the high frequency signal V_{REF} and the DC bias voltage V_{DC} may be used.

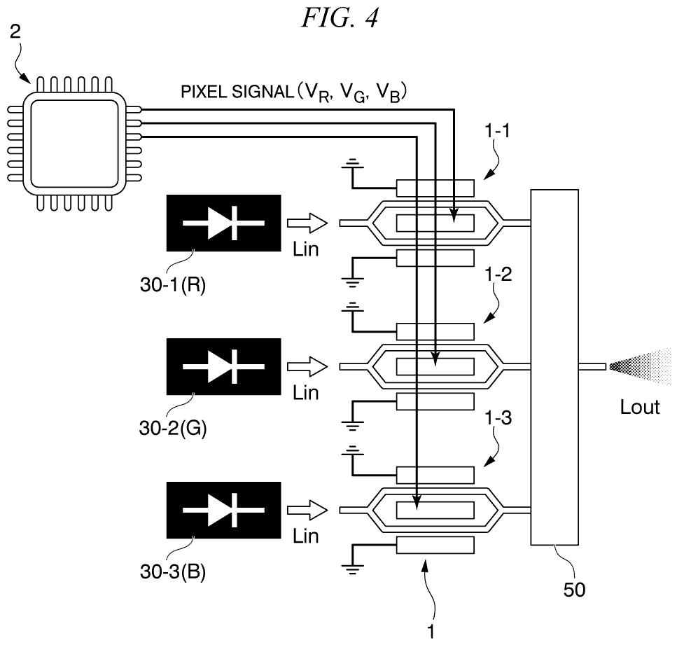

The Mach-Zehnder optical modulator 1 has a modulation curve (operating characteristic curve; see FIG. 3) specific to the optical modulator, and input light is modulated by a modulation signal Vₘ applied in accordance with this modulation curve, and is output as an output optical signal. When the modulation signal Vm contains a DC bias voltage V_{DC}, which is a direct current component, a phenomenon occurs in which the modulation curve (operating characteristic curve) shifts over time (DC drift) depending on the polarity of the DC bias voltage V_{DC}.

FIG. 3 is a diagram for explaining a case where the modulation curve of the LN optical modulator shifts to the positive side due to DC drift caused by a positive bias voltage.

The modulation curve of an LN optical modulator is expressed as the optical output (optical intensity) of the output light periodically increasing and decreasing with increasing applied voltage.

In FIG. 3, the symbol C100 indicates a modulation curve when no DC drift occurs, and C101 is a modulation curve when DC drift occurs. D100 is an output optical signal when no DC drift occurs, and D101 is an output optical signal when DC drift occurs. A100 is a modulation signal (driving voltage).

FIG. 3 shows an example in which the voltages at which the minimum (0) and maximum (P₀) of the optical output corresponding to the input signal as a binary signal are obtained are V₀ and V₁, respectively. If the voltages V₀ and V₁ are fixed when DC drift occurs, the optical output at voltages V₀ and V₁ will be P₂ and P₁, respectively, due to the periodicity of the modulation curve. If the amount of drift is dV, in order to maintain the optical output before the DC drift after the DC drift, it becomes necessary to compensate for the DC drift by setting the voltages V₀ and V₁ to voltages (V₀+dV) and (V₁+dV), respectively.

Although FIG. 3 shows the DC drift due to a positive bias voltage, the DC drift due to a negative bias voltage moves to the negative side.

The optical modulator disclosed herein is an optical modulator for an image display device that displays an image on an image display surface (projection surface) by scanning a combined light of multiple color laser beams pixel by pixel at a predetermined time step, and includes multiple Mach-Zehnder optical modulation units. Each Mach-Zehnder optical modulation unit has a Mach-Zehnder optical waveguide made of a ridge formed in a ferroelectric thin film represented by the chemical formula ABX₃, and an electrode for applying an electric field to the Mach-Zehnder optical waveguide.

As the ferroelectric thin film represented by the chemical formula ABX₃, oxide ferroelectrics such as barium titanate (BaTiO₃), lithium niobate (LiNbO₃), lithium tantalate (LiTaO₃), etc., can be used. In particular, lithium niobate (LiNbO₃) is preferable.

The optical modulator according to the present disclosure further includes a power supply for applying a pixel voltage independently to each of the multiple Mach-Zehnder optical modulation units, and a control section 2 for controlling the power supply, and the control section 2 has an integrating circuit capable of calculating an integrated value of the pixel voltage applied to each of the multiple Mach-Zehnder optical modulation units (1-1, 1-2, 1-3), and the control section 2 can control the power supply so as to continuously apply a pixel voltage independently to each of the multiple Mach-Zehnder optical modulation units (1-1, 1-2, 1-3) at a predetermined applied voltage width, and the control section 2 can further control the power supply so as to apply a shift voltage to each of the multiple Mach-Zehnder optical modulation units (1-1, 1-2, 1-3) at the timing when the integrated value of the pixel voltage integrated in the integrating circuit for any of the multiple Mach-Zehnder optical modulation units (1-1, 1-2, 1-3) reaches a predetermined value.

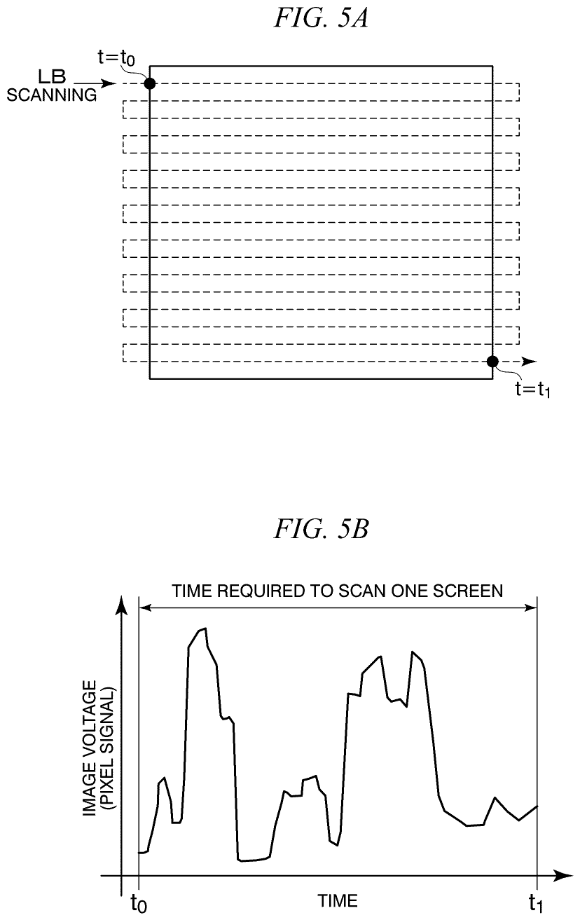

FIG. 4 is a schematic diagram of an image display device including a light modulator according to the present disclosure.

The image display device shown in FIG. 4 is an image display device capable of full-color display, including red (R), green (G), and blue (B) visible light laser light sources 30-1, 30-2, and 30-3, which are arranged so that they can be incident on Mach-Zehnder optical modulation units 1-1, 1-2, and 1-3, respectively; however, the optical modulator according to the present disclosure can be applied to any image display device that includes two or more light sources that emit light of different colors. Reference numeral 50 denotes an optical multiplexer.

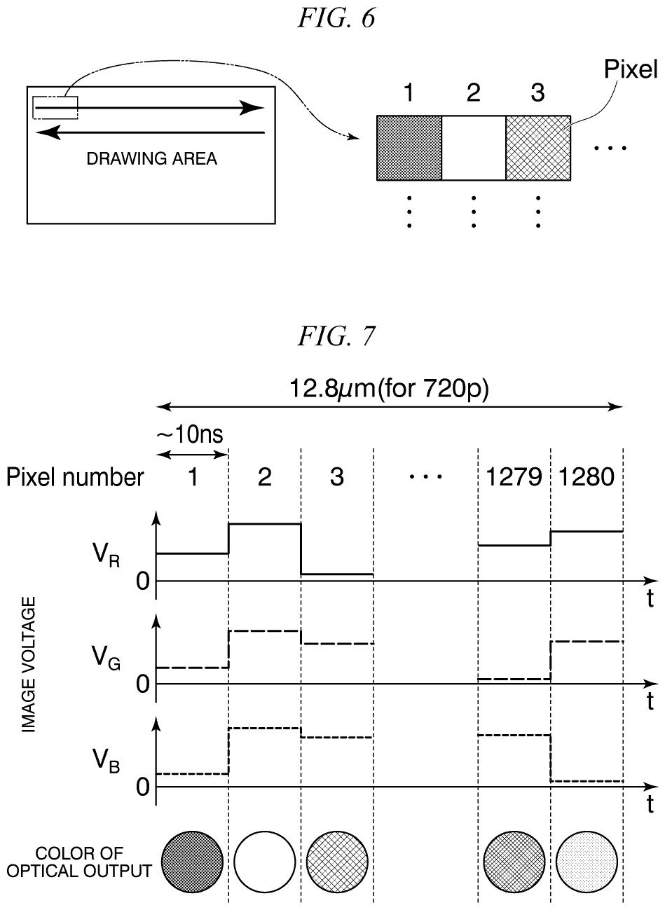

FIG. 5A shows a drawing area on an image display surface, and is a conceptual diagram showing an example of a scanning method in which an image is displayed by changing the light intensity (color tone) for each pixel while scanning a laser beam using an image display device equipped with an optical modulator according to the present disclosure. FIG. 5B is a conceptual diagram showing a pattern of pixel voltages (pixel signals) applied to one of the Mach-Zehnder optical modulators for RGB on the vertical axis, with time on the horizontal axis.

FIG. 5A, a laser beam (LB) is scanned in sequence to form an image. The start time of the scan for displaying one image is t0, and the end time of the scan is t1. The arrow in FIG. 5A indicates the scanning direction of the laser light, and the laser light scans one pixel at a time from left to right, and when it reaches the right end, it goes down one row and scans one pixel at a time from right to left, and when it reaches the left end, it goes down one row and scans one pixel at a time from left to right, repeating this scanning (raster scanning). This scanning method is one example, and any scanning method that scans one pixel at a time may be used.

As the laser beam moves through each dot (pixel) of the image, the color of the laser changes over time. It takes a certain amount of time to form one image, but the human eye cannot keep up with this speed, so it is recognized as one image. The scanning speed of the laser beam is generally around 100 to 500 MHz (a speed at which the entire image switches 60 times per second). For example, if the drawing time for one pixel is 10 ns (nanoseconds), this is much shorter than the time constant of DC drift (up to 200 ms (milliseconds)).

Color tones are changed by changing the light intensity of the three primary colors of light: red (R), green (G), and blue (B). For example, if the intensity of each color is changed using 8 bits of red, 8 bits of green, and 8 bits of blue, the combined color will have 24-bit color tones (approximately 16.77 million colors) (24-bit color method). In the 24-bit color method, each RGB color has 8 bits of information, and each can be reproduced in 256 gradations. Each RGB has a voltage value ranging from 0 to 255; for example, when all RGB are 0, the result is black, and when all are 255, the result is white.

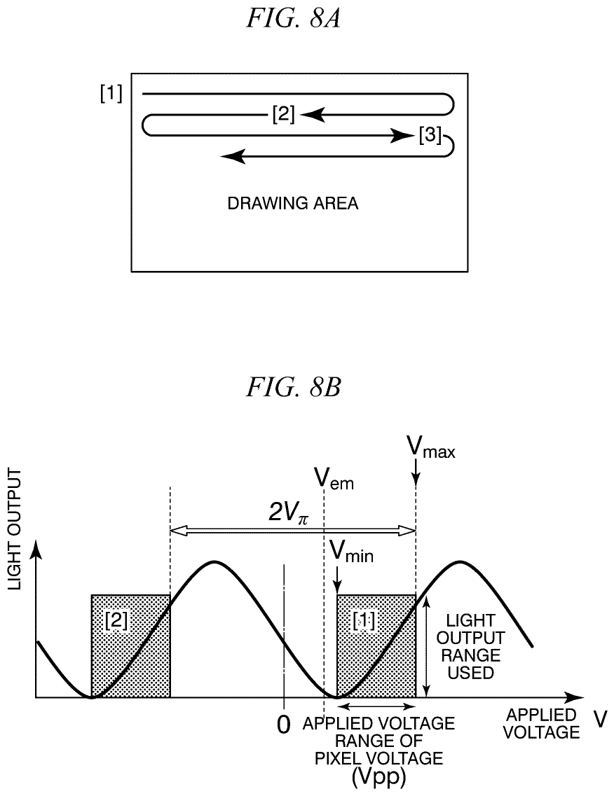

FIG. 6 conceptually shows an arrangement of three consecutive pixels among the pixels that make up one image.

The color displayed by each pixel is determined by a combination of the light intensities of three colors: red (R), green (G), and blue (B).

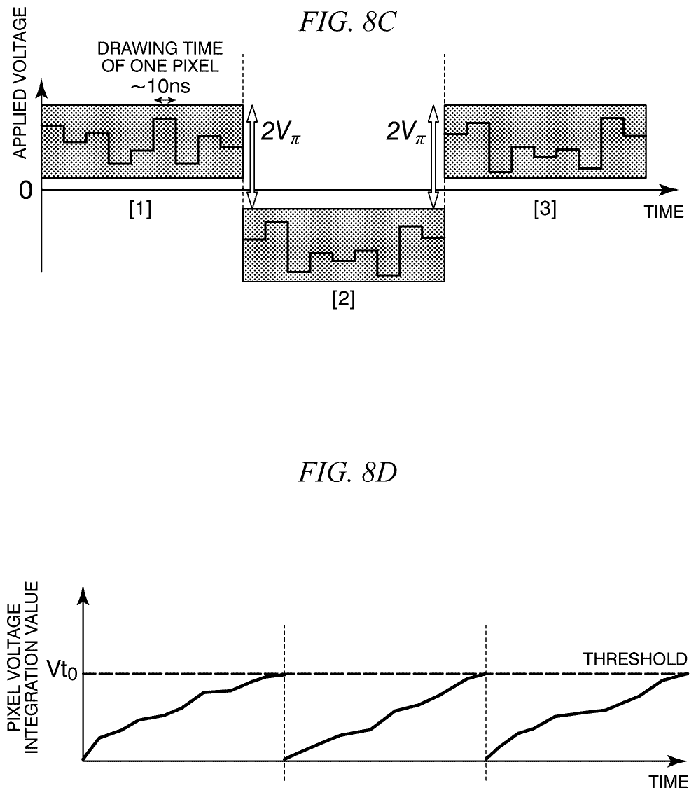

FIG. 7 conceptually illustrates combinations of pixel voltages (pixel signals) for each of RGB in each of 1280 pixels in one column when the number of pixels is “1280×720.”

The 1280 pixels are named, from left to right, as pixel number 1, pixel number 2, pixel number 3, . . . , pixel number 1279, and pixel number 1280. When the drawing time for one pixel is 10 ns, the time required for scanning one row is 12.8 μs (microseconds), and the time required for displaying one screen is approximately 10 ms (milliseconds).

In the optical modulator of the present disclosure, the control section has an integrating circuit capable of determining an integrated value of pixel voltages applied to each of the multiple Mach-Zehnder optical modulation units. In the driving example shown in FIG. 7, when scanning one column, if the pixel voltages applied to the Mach-Zehnder light modulation unit for red (R) for pixel number 1, pixel number 2, pixel number 3, . . . , pixel number 1279, and pixel number 1280 are V_{R}(1), V_{R}(2), V_{R}(3), . . . , V_{R}(1279), and V_{R}(1280), respectively, after the application time of these pixel voltages, a DC drift corresponding to the pixel voltage integrated value obtained by integrating each pixel voltage x one pixel drawing time can occur. Similarly, in the green (G) Mach-Zehnder optical modulation section, a DC drift may occur according to an integrated pixel voltage value obtained by integrating each pixel voltage of V_{G}(1), V_{G}(2), V_{G}(3), . . . , V_{G}(1279), and V_{G(}1280) times one pixel drawing time, and in the blue (B) Mach-Zehnder optical modulation section, a DC drift may occur according to an integrated pixel voltage value obtained by integrating “each pixel voltage of V_{B}(1), V_{B}(2), V_{B}(3), . . . , V_{B}(1279), and V_{B}(1280) times one pixel drawing time.”

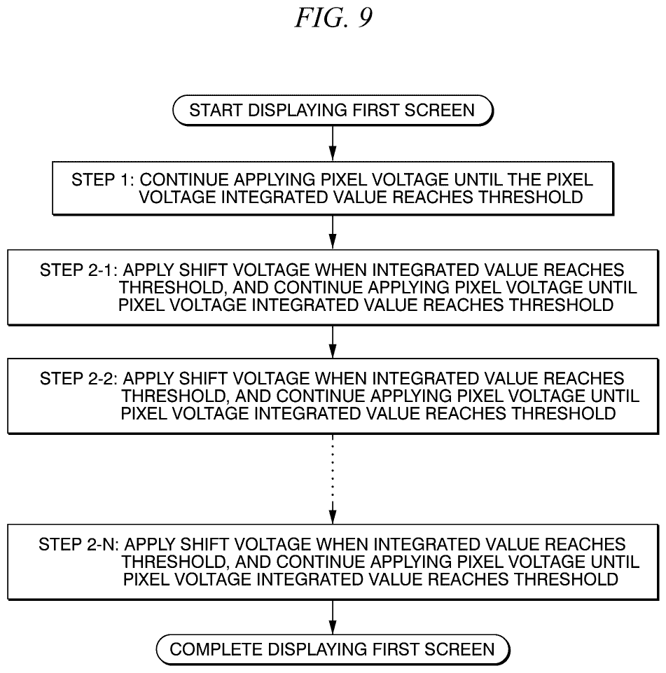

An example of a method for controlling application of a pixel voltage to a Mach-Zehnder optical modulation section, which is performed in the optical modulator of the present disclosure, will be conceptually described with reference to FIGS. 8A to 8D

In FIGS. 8A to 8D, [1] to [3] correspond to each other.

In this optical modulator, when the integrated value of the pixel voltage in any of the multiple Mach-Zehnder optical modulation units (1-1, 1-2, 1-3) reaches a predetermined value (Vt₀: see FIG. 8D), a shift voltage that is an even multiple (twice in this example; see FIGS. 8B and 8C) of the half-wavelength voltage Vπ is applied to the multiple Mach-Zehnder optical modulation units (1-1, 1-2, 1-3), thereby compensating for the DC drift caused by driving.

FIG. 8A shows a drawing area on an image display surface, and is a conceptual diagram showing an example of a scanning method.

In FIG. 8A, [1] indicates the first (first) scan of the raster scan, [2] indicates the second scan of the raster scan, and [3] indicates the third scan of the raster scan. The timing at which the first scan [1], the second scan [2], and the third scan [3] each end is the timing at which the integrated value of the pixel voltage in any of the Mach-Zehnder optical modulators reaches a predetermined value (Vt₀: see FIG. 8D).

FIG. 8B is a diagram showing control for shifting the range of the applied voltage width Vpp of the pixel voltage by applying a shift voltage (ΔV) of an even multiple (twice in this example) of a half-wave voltage (Vπ) to each of a plurality of Mach-Zehnder optical modulation units. FIG. 8B illustrates one of the plurality of Mach-Zehnder optical modulation units.

In FIG. 8B, [1] indicates the range of the applied voltage width Vpp in the first scan [1] of the raster scan, and indicates the range of the applied voltage width Vpp before the application of the shift voltage. Also, in FIG. 8B, [2] indicates the range of the applied voltage width Vpp in the second scan [2] of the raster scan, and indicates the range of the applied voltage width Vpp after the application of the shift voltage. Although not shown in FIG. 8B, when the shift voltage is applied after the second scan [2], the range of the applied voltage width Vpp in the third scan [3] almost overlaps with the range of the applied voltage width Vpp in the first scan [1].

FIG. 8C shows the application patterns of pixel voltages over time for the first scan [1], the second scan [2], and the third scan [3] shown in FIG. 8A. FIG. 8D shows the control of shifting the range of the applied voltage width Vpp of the pixel voltage by applying a shift voltage at the timing when the integrated value of the pixel voltage reaches a predetermined value.

FIG. 8C, a positive pixel voltage was applied in the first scan [1], but a negative pixel voltage is applied in the second scan [2] by applying a shift voltage of 2Vπ to each of the Mach-Zehnder optical modulation units at the timing of completion of the first scan [1] (in other words, when the integrated value of the pixel voltage reaches a predetermined value). Furthermore, a positive pixel voltage is applied in the third scan [3] by applying a shift voltage of 2Vπ to each of the Mach-Zehnder optical modulation units at the timing of completion of the second scan [2].

If the application of the shift voltage at the timing of completion of the first scan [1] is referred to as the application of a negative shift voltage, the control unit controls the application of the shift voltage at the timing of completion of the second scan [2] to be a positive shift voltage, and controls the power supply so that the application of the negative shift voltage and the application of the positive shift voltage are repeated alternately.

In this way, by controlling so as to change the polarity of the voltage applied to the Mach-Zehnder optical modulation unit every time the integrated value of the pixel voltage reaches a predetermined value, it is possible to compensate for the DC drift.

In the examples shown in FIGS. 8A to 8C, a shift voltage (ΔV) that is an even multiple (twice in this example) of the half-wave voltage (Vπ) is applied, but a shift voltage of another magnitude may also be applied.

For example, the shift voltage may be applied to have an applied voltage width at a position symmetrical with respect to the extreme value of the optical output in each modulation curve of a plurality of Mach-Zehnder optical modulation units. A specific explanation will be given with reference to FIG. 8B. In the modulation curve shown in FIG. 8B, there is a nearest minimum on the positive side and a nearest maximum on the negative side of an applied voltage of 0V. The shift voltage may be applied to have an applied voltage width at a position symmetrical with respect to an axis of symmetry passing through the minimum value, or the shift voltage may be applied to have an applied voltage width at a position symmetrical with respect to an axis of symmetry passing through the maximum value.

The optical modulator of the present disclosure allows for DC drift compensation for each color, thereby allowing the same output light to be maintained.

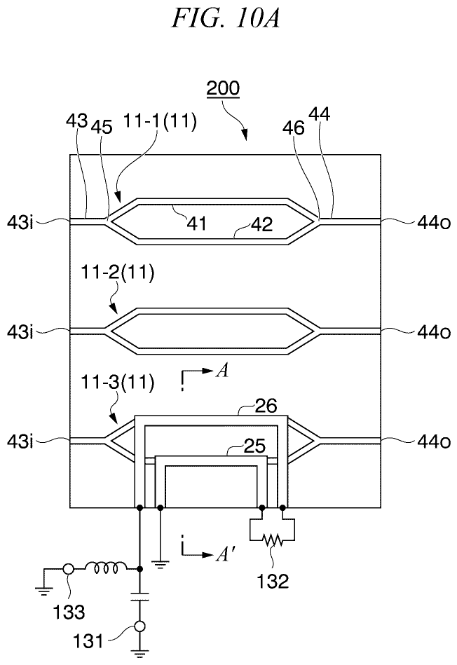

FIG. 9 is a flow chart showing an example of control executed by the control unit on the optical modulator during image formation, which shows control steps from the start of displaying the first screen to the completion of displaying the first screen.

In step 1, control is performed so that application of a pixel voltage to each pixel is continued until an integrated value of the image voltage applied to the Mach-Zehnder optical modulation unit of each color in response to scanning of the laser light reaches a predetermined value.

In step 2-1, when the integrated value of the image voltage reaches a predetermined value, a shift voltage is applied to the Mach-Zehnder optical modulation unit of each color, and control is performed so that the application of the pixel voltage to each pixel is continued until the integrated value of the next image voltage reaches the predetermined value.

In step 2-2, when the integrated value of the image voltage reaches a predetermined value, a shift voltage is applied to the Mach-Zehnder optical modulation unit of each color, and control is performed so that the application of the pixel voltage to each pixel is continued until the integrated value of the next image voltage reaches the predetermined value.

The subsequent flow is also a repetition of step 1-1, step 2-1, and step 2-2. As described above, the control unit controls to repeat step 1 in which the application of the pixel voltage is continued, and step 2 in which, at the timing when the integrated value of the image voltage reaches a predetermined value, the shift voltage is applied to the Mach-Zehnder optical modulation unit of each color and the application of the pixel voltage is continued, in order, until the formation of the first screen is completed.

After the formation of the first screen, the control unit controls the process to repeat steps 1 and 2 until the formation of the second screen is completed, and so on until the formation of the last screen is completed.

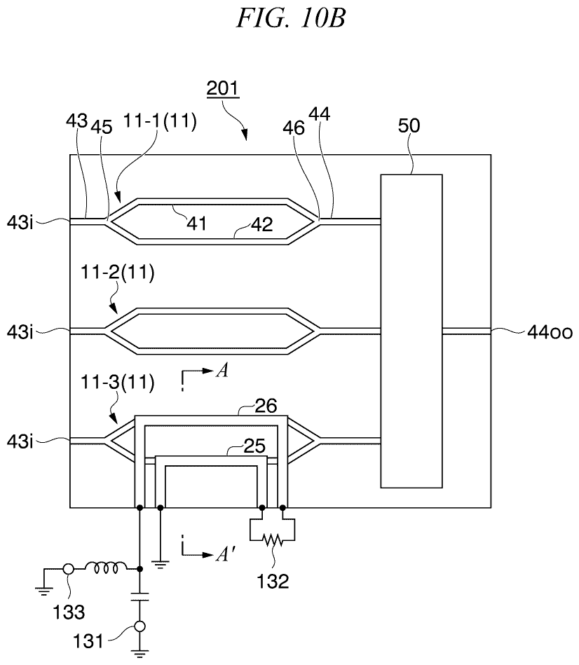

FIG. 10A is a schematic plan view of an optical modulator according to the present disclosure having three Mach-Zehnder optical waveguides 11 as shown in FIG. 2.

The optical modulator 200 shown in FIG. 10A includes three Mach-Zehnder optical waveguides 11-1, 11-2, and 11-3, but three is just an example and the optical modulator 200 may include two or four or more.

In the optical modulator 200 shown in FIG. 10A, light inputted from each input port 43i of the three Mach-Zehnder optical waveguides 11-1, 11-2, and 11-3 is outputted from the output port 44o of each optical waveguide.

The electrode configuration and the circuit diagram shown in FIG. 10A are an example. FIG. 10A shows a case where a DC bias voltage is superimposed on a high frequency signal applied to the electrodes 25 and 26.

The electrodes 25 and 26 are electrodes that apply a modulated voltage to each of the Mach-Zehnder optical waveguides 11-1, 11-2, and 11-3. The electrode 25 is an example of a first electrode, and the electrode 26 is an example of a second electrode. The power supply 131 is a part of a high-frequency signal pulse generation control circuit that applies a modulated voltage to each of the Mach-Zehnder optical waveguides 11. The power supply 133 is a part of a DC bias control circuit that applies a DC bias voltage to each of the Mach-Zehnder optical waveguides 11. For the sake of simplicity, the electrodes 25 and 26 are drawn only on the part of the Mach-Zehnder optical waveguide 11-3.

FIG. 10B is a schematic plan view of another example of an optical modulator according to the present disclosure, which is the same as the optical modulator shown in FIG. 10A except that it has an optical multiplexer.

In the optical modulator 201 shown in FIG. 10B, the light inputted from each of the input ports 43i of the three Mach-Zehnder optical waveguides 11-1, 11-2, and 11-3 is multiplexed in the optical multiplexing section 50 and outputted from one output port 44oo.

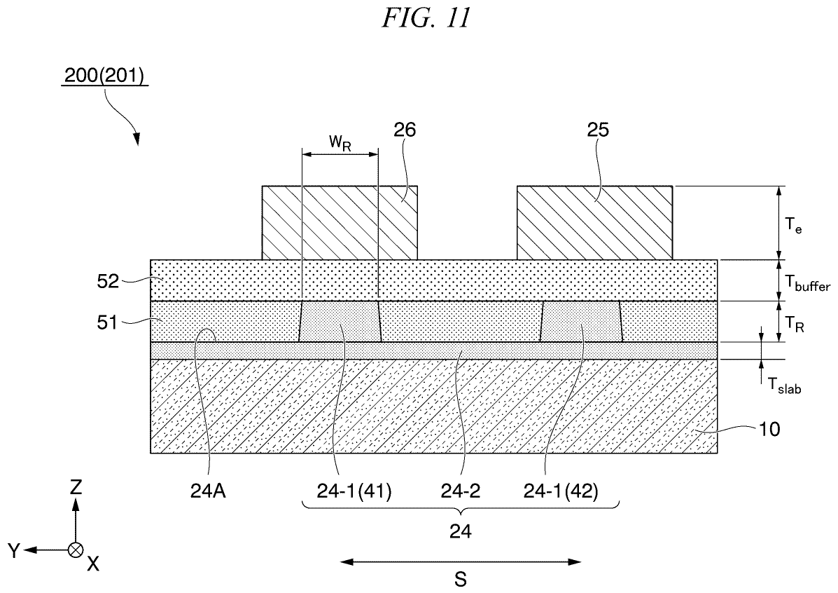

FIG. 11 is a schematic cross-sectional view of the optical modulator shown in FIG. 10A taken along line AA′. The same is true for the schematic cross-sectional view of the optical modulator shown in FIG. 10B taken along line AA′.

The optical modulator 200 (201) shown in FIG. 11 has a substrate 10 made of a material different from lithium niobate, and a lithium niobate film 24 formed on the main surface of the substrate 10.

As shown in FIG. 11, the lithium niobate film 24 is composed of a ridge-type optical waveguide 24-1 (corresponding to the first ridge-type optical waveguide 41 and the second ridge-type optical waveguide 42) protruding from the first surface 24A, and a slab layer 24-2 which is the portion other than the ridge. However, the lithium niobate film 24 may be composed of only the ridge-type optical waveguide without having the slab layer.

When the optical modulator 200 (201) shown in FIG. 11 is used in an eyeglass-type image display device, the thickness (Tslab) of the slab layer 24-2 of the lithium niobate film 24 is preferably 0.1 to 0.3 μm, and the thickness (TR) of the ridge-type optical waveguide 24-1 of the lithium niobate film 24 is preferably 0.5 to 1.0 μm.

This is because if the thickness (TR) of the ridge-type optical waveguide 24-1 is small, light will not propagate, and if it is large, the propagating light will be multi-mode.

When the optical modulator 200 (201) shown in FIG. 11 is used in an eyeglass-type image display device, the distance(S) between the ridge-type optical waveguides 24-1 is preferably 2 to 12 μm.

This is because by making S small, the efficiency of the electric field applied to the ridge-type optical waveguide 24-1 can be increased.

Furthermore, it is preferable that the width (WR) of the top surface of the ridge-type optical waveguide 24-1 is 0.3 to 1.2 μm.

This is because if the waveguide width is small, light will not propagate, and if it is large, the propagating light will be multi-mode.

Examples of the substrate 10 include a sapphire substrate, a Si substrate, and a thermally oxidized silicon substrate.

Since the optical multiplexing functional layer 20 is made of a lithium niobate (LiNbO₃) film, there are no particular limitations on the substrate as long as it has a lower refractive index than the lithium niobate film, but a sapphire single crystal substrate or a silicon single crystal substrate is preferred as a substrate on which a single crystal lithium niobate film can be formed as an epitaxial film.

The crystal orientation of the single crystal substrate is not particularly limited, but since, for example, a c-axis oriented lithium niobate film has three-fold symmetry, it is desirable for the underlying single crystal substrate to have the same symmetry, and in the case of a sapphire single crystal substrate, a c-plane substrate is preferred, and in the case of a silicon single crystal substrate, a (111) plane substrate is preferred.

The lithium niobate film is, for example, a c-axis oriented lithium niobate film. The lithium niobate film is, for example, an epitaxial film epitaxially grown on the substrate 10. The epitaxial film is a single crystal film whose crystal orientation is aligned by the underlying substrate. The epitaxial film is a film having a single crystal orientation in the z direction and the xy in-plane direction, and the crystals are aligned in the x-axis, y-axis, and z-axis directions. Whether the film formed on the substrate 10 is an epitaxial film can be proved by, for example, checking the peak intensity and pole at the orientation position in 2θ-θ X-ray diffraction.

Specifically, when measured by 2θ-θ X-ray diffraction, all peak intensities other than the target plane are 10% or less, preferably 5% or less, of the maximum peak intensity of the target plane. For example, when the lithium niobate film is a c-axis oriented epitaxial film, the peak intensities other than the (00L) plane are 10% or less, preferably 5% or less, of the maximum peak intensity of the (00L) plane. Here, (00L) is a general designation for equivalent planes such as (001) and (002).

Moreover, the conditions for confirming the peak intensity at the orientation position described above only indicate the orientation in one direction. Therefore, even if the above conditions are obtained, if the crystal orientation is not aligned in the plane, the intensity of the X-rays will not increase at a specific angle position, and no poles will be observed. For example, when the lithium niobate film is a lithium niobate film, since LiNbO₃ has a trigonal crystal structure, there are three poles of LiNbO₃ (014) in the single crystal. In the case of lithium niobate, it is known that the epitaxial growth occurs in a so-called twin state in which crystals rotated 180° around the c-axis are symmetrically bonded. In this case, the three poles are symmetrically bonded to two, so there are six poles. In addition, when a lithium niobate film is formed on a silicon single crystal substrate with a (100) plane, the substrate is four-fold symmetric, so 4×3=12 poles are observed. In this disclosure, a lithium niobate film epitaxially grown in a twin state is also included in the epitaxial film.

The composition of lithium niobate is LiₓNbA_{y}O_{z}. A is an element other than Li, Nb, and O. x is 0.5 or more and 1.2 or less, and preferably 0.9 or more and 1.05 or less. y is 0 or more and 0.5 or less. z is 1.5 or more and 4.0 or less, and preferably 2.5 or more and 3.5 or less. The element A is, for example, K, Na, Rb, Cs, Be, Mg, Ca, Sr, Ba, Ti, Zr, Hf, V, Cr, Mo, W, Fe, Co, Ni, Zn, Sc, and Ce, and two or more of these elements may be combined.

Furthermore, the lithium niobate film may be a lithium niobate single crystal thin film bonded onto a substrate.

### (Protective Layer 51)

As shown in FIG. 2, the protective layer 51 is disposed between the slab layer 24-2 of the lithium niobate film 24 and the buffer layer 52. The protective layer 51 is made of a dielectric material having a smaller refractive index than the lithium niobate film 24. As the material of the protective layer 51, for example, silicon oxide (SiO₂), aluminum oxide (Al₂O₃), lanthanum oxide (La₂O₃), or a composite of these oxides can be used. As the composite of the oxide, for example, LaAlSiInO can be used. Among the above, it is preferable to use silicon oxide (SiO₂) as the material of the protective layer 51.

### (Buffer Layer 52)

The buffer layer 52 is formed on the lithium niobate film 24 and the protective layer 51, and prevents visible light propagating through the lithium niobate film 24 from being absorbed by the electrode layer.

The buffer layer 52 is made of a dielectric material having a smaller refractive index than the lithium niobate film 24. The dielectric material constituting the buffer layer 52 preferably has a dielectric constant of 7 or more, because this can reduce the electric field efficiency VπL.

Specific examples of the material of the buffer layer 52 include aluminum oxide (Al₂O₃, dielectric constant 7) and LaAlSiInO (dielectric constant 11).

The material of the buffer layer 52 may be the same as that of the protective layer 51 or may be a different material.

The thickness (Tbuffer) of the buffer layer 52 is preferably 0.4 μm or more and 1 μm or less, because the electric field efficiency VπL can be reduced.

### (Electrodes 25, 26)

When the optical modulator of the present disclosure is used in an eyeglass-type image display device, the width (We) of the electrodes 25, 26 is preferably 1.0 to 4.0 μm.

This is because the electric field efficiency VIL can be reduced.

When the optical modulator of the present disclosure is used in an eyeglass-type image display device, the thickness (Te) of the electrodes 25, 26 is preferably 0.1 to 5 μm.

This is because when the modulation frequency is high, the microwave propagates more efficiently when the electrode cross-sectional area is large.

A ridge-type optical waveguide is formed by a bulk lithium niobate layer attached to a substrate;

The C-axis of the lithium niobate may be parallel to the main surface of the substrate.

### Light Source Module

A light source module according to the present disclosure includes an optical modulator according to the present disclosure and a plurality of laser light sources.

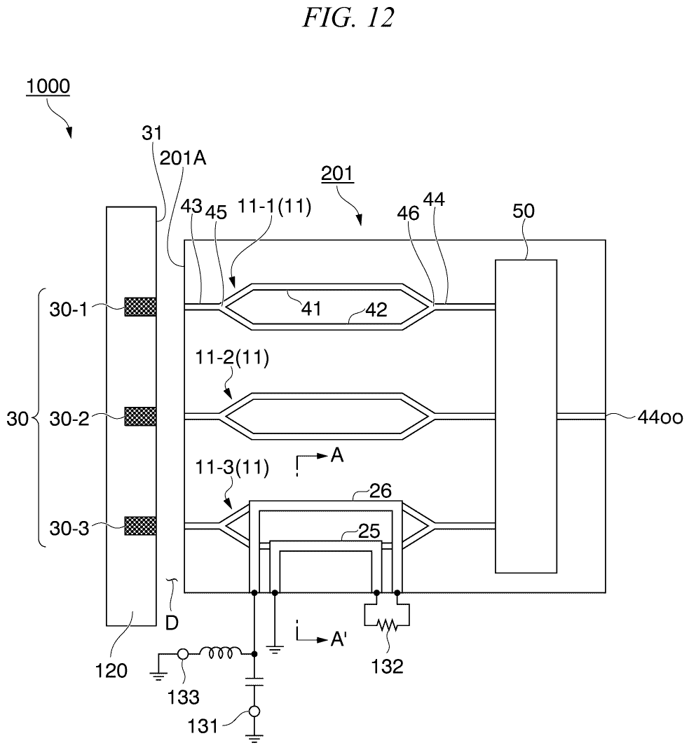

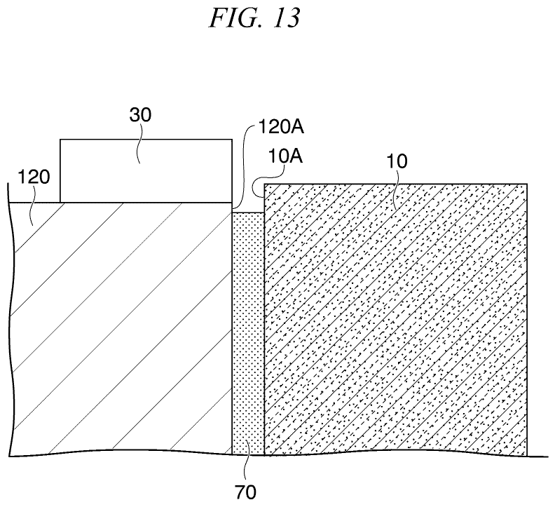

FIG. 12 is a schematic plan view of a light source module according to the present disclosure. FIG. 12 shows an example of a light source module including the optical modulator 201 shown in FIG. 11. FIG. 13 is a schematic cross-sectional view of a part of the light source module shown in FIG. 12 cut along the XZ plane, depicting only a part near the joint.

The light source module 1000 shown in FIG. 12 includes an optical modulator 201 and three laser light sources 30 (30-1, 30-2, 30-3) that emit light to be modulated by the optical modulator 201.

Various laser elements can be used as the laser light source 30. The laser light source 30 can emit visible light. In this case, the light source module 1000 is a visible light source module.

The three laser light sources 30-1, 30-2, and 30-3 may be, for example, commercially available laser diodes (LDs) that emit red, green, and blue light. The red light may have a peak wavelength of 610 nm or more and 750 nm or less, the green light may have a peak wavelength of 500 nm or more and 560 nm or less, and the blue light may have a peak wavelength of 435 nm or more and 480 nm or less.

In the light source module 1000, the laser light sources 30-1, 30-2, and 30-3 are respectively an LD that emits green light, an LD that emits blue light, and an LD that emits red light. The LDs 30-1, 30-2, and 30-3 are disposed at intervals in a direction substantially perpendicular to the emission direction of the light emitted from each LD, and are provided on the upper surface of the subcarrier 120.

The LD 30 can be mounted as a bare chip on the subcarrier 120. The subcarrier 120 is made of, for example, aluminum nitride (AlN), aluminum oxide (Al₂O₃), silicon (Si), or the like.

The subcarrier 120 can be directly bonded to the substrate 10 via a metal bonding layer. This configuration makes it possible to further reduce the size by eliminating spatial coupling or fiber coupling.

By configuring the subcarrier 120 and the substrate 10 to be joined via a metal bonding layer, the relative positions of the subcarrier 120 and the substrate 10 can be adjusted during manufacture to align the optical axis position of the laser light so that the optical axis of each visible light laser coincides with the axis of each optical waveguide 43 (active alignment).

In the light source module 1000, the light exit surface 31 of the LD 30 and the light entrance surface (side surface) 201A of the optical modulator 201 are arranged at a predetermined interval. The light entrance surface 201A faces the light exit surface 31, and there is a gap D between the light exit surface 31 and the light entrance surface 201A in the x direction. Since the light source module 1000 is exposed to the air, the gap D is filled with air. Since the gap D is filled with the same gas (air), it is easy to make each color light emitted from the LD 30 enter the entrance path while satisfying a predetermined coupling efficiency. When the light source module 1000 is used for AR glasses and VR glasses, the size of the gap (spacing) D in the x direction is, for example, greater than 0 μm and less than 5 μm, taking into account the amount of light required for the AR glasses and VR glasses.

### Optical Engine and XR Glasses

In this specification, an optical engine refers to a device that includes a plurality of light sources, an optical system including a multiplexing section that combines a plurality of light beams emitted from the plurality of light sources into a single beam of light, an optical scanning mirror configured to reflect the light emitted from the optical system at a different angle so as to display an image, and a control element that controls the optical scanning mirror.

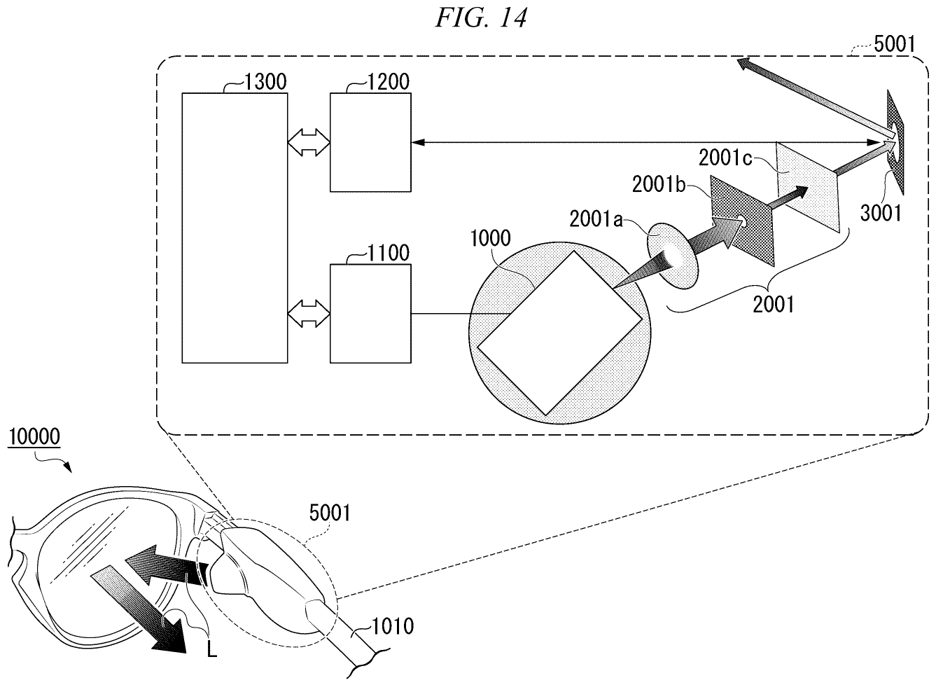

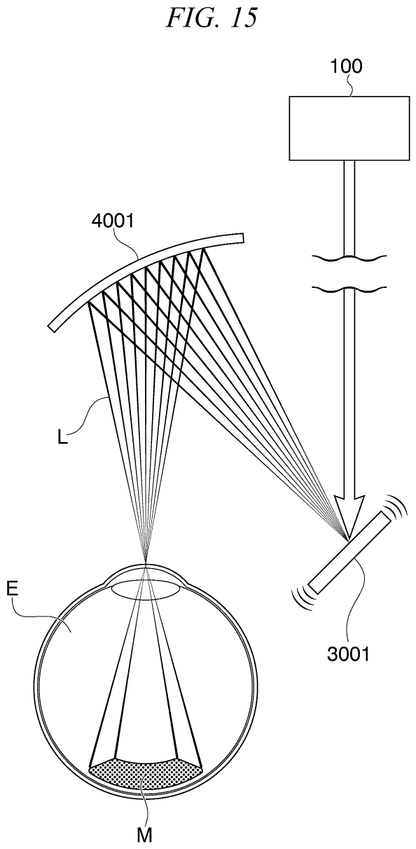

FIG. 14 is a conceptual diagram for explaining an example of the XR glasses of the present disclosure. FIG. 15 is a conceptual diagram showing a state in which an image is directly projected onto a retina by a laser light emitted from a light source module in the XR glasses shown in FIG. 14. The symbol L is an image display light.

The XR glasses (eyeglasses) 10000 of the present disclosure are glasses-type terminals. XR is a general term for virtual reality (VR), augmented reality (AR), and mixed reality. The symbol L shown in FIG. 15 denotes image display light.

The XR glasses 10000 of the present disclosure shown in FIG. 14 are configured such that the light source module 1000 according to the above-described embodiment is mounted on an optical engine 5001 disposed on a frame 1010. As shown in FIG. 14, the optical engine 5001 has a light source module 1000, an optical scanning mirror 3001, an optical system 2001 connecting the light source module 1000 and the optical scanning mirror 3001, a laser driver 1100, an optical scanning mirror driver 1200, and a video controller 1300 that controls these drivers.

For example, a MEMS mirror can be used as the optical scanning mirror 3001. In order to project a 2D image, it is preferable to use, as the optical scanning mirror 3001, a two-axis MEMS mirror that vibrates so as to reflect laser light by changing angles in the horizontal direction (X direction) and the vertical direction (Y direction).

The optical system 2001 optically processes the laser light emitted from the light source module 1000. As the optical system 2001, for example, one having a collimator lens 2001a, a slit 2001b, and an ND filter 2001c can be used. The optical system 2001 shown in FIG. 14 is an example, and other configurations may be used.

In the XR glasses 10000 of the present disclosure shown in FIG. 14, as shown in FIG. 15, laser light R irradiated from a light source module 1000 attached to a frame 1010 is reflected by a light scanning mirror 3001, and further reflected by a lens 4001 of the XR glasses 10000, and enters a person's eyeball E as image display light L, so that an image (video) can be directly projected onto the retina M.

The XR glasses 10000 of the present disclosure are equipped with the light source module 1000 of the present disclosure, and therefore have reduced electric field efficiency.

While preferred embodiments of the invention have been described and illustrated above, it should be understood that these are exemplary of the invention and are not to be considered as limiting. Additions, omissions, substitutions, and other modifications can be made without departing from the scope of the present disclosure. Accordingly, the invention is not to be considered as being limited by the foregoing description, and is only limited by the scope of the appended claims.

### REFERENCE SYMBOL

1. Mach-Zehnder optical modulator
2. Control Unit
10 Substrate
100, 200, 201 Optical modulator
1000 Light source module
5001 Optical Engine
10000 XR Glasses

1. An optical modulator for an image display device that displays an image on an image display surface by scanning a combined light of a plurality of color laser beams pixel by pixel at a predetermined time step, the optical modulator comprising:
a plurality of Mach-Zehnder optical modulation units, each of which has a Mach-Zehnder optical waveguide formed of a ridge formed in a ferroelectric thin film represented by the chemical formula ABX3 and an electrode for applying an electric field to the Mach-Zehnder optical waveguide;
a power supply for applying a pixel voltage to each of the plurality of Mach-Zehnder optical modulation units independently;
a control unit configured to control the power supply, wherein
the control unit comprises an integrating circuit capable of calculating an integrated value of the pixel voltages applied to each of the plurality of Mach-Zehnder optical modulation units,
the control unit is configured to control the power supply so as to continuously apply the pixel voltage at a predetermined applied voltage width to each of the plurality of Mach-Zehnder optical modulation units independently;
the control unit is configured to further control the power supply to apply a shift voltage that is an even multiple of a half-wavelength voltage to each of the plurality of Mach-Zehnder optical modulation units at a timing when an integrated value of the pixel voltage integrated by the integrating circuit reaches a predetermined value for any of the plurality of Mach-Zehnder optical modulation units.

2. An optical modulator for an image display device that displays an image on an image display surface by scanning a combined light of a plurality of color laser beams pixel by pixel at a predetermined time step,
a plurality of Mach-Zehnder optical modulation units, each of which has a Mach-Zehnder optical waveguide formed of a ridge formed in a ferroelectric thin film represented by the chemical formula ABX3 and an electrode for applying an electric field to the Mach-Zehnder optical waveguide;
a power supply for applying a pixel voltage to each of the plurality of Mach-Zehnder optical modulation units independently;
a control unit configured to control the power supply, wherein
the control unit comprises an integrating circuit capable of calculating an integrated value of the pixel voltages applied to each of the plurality of Mach-Zehnder optical modulation units,
the control unit is configured to control the power supply so as to continuously apply the pixel voltage at a predetermined applied voltage width to each of the plurality of Mach-Zehnder optical modulation units independently;
the control unit is configured to further control the power supply to apply a shift voltage that shifts an applied voltage width to a position symmetrical with respect to an extreme value of optical output in a modulation curve of each of the plurality of Mach-Zehnder optical modulation units to each of the plurality of Mach-Zehnder optical modulation units at a timing when an integrated value of the pixel voltage integrated by the integrating circuit reaches a predetermined value for any of the plurality of Mach-Zehnder optical modulation units.

3. The optical modulator according to claim 1, wherein the Mach-Zehnder optical waveguide is made of C-axis oriented lithium niobate.

4. The optical modulator according to claim 2, wherein the Mach-Zehnder optical waveguide is made of C-axis oriented lithium niobate.

5. The optical modulator according to claim 1, wherein the Mach-Zehnder optical waveguide is made of X-cut lithium niobate.

6. The optical modulator according to claim 2, wherein the Mach-Zehnder optical waveguide is made of X-cut lithium niobate.

7. A visible light source module comprising:
the optical modulator according to claim 1; and
a plurality of visible light laser light sources each emitting a plurality of colored laser beams.

8. An optical engine comprising:
the visible light source module according to claim 7; and
an optical scanning mirror configured to reflect the light emitted from the visible light source module at a different angle so as to display an image.

9. An image display device comprising the optical engine according to claim 8.

10. The image display device according to claim 9, wherein the image display device is an XR glass.

11. A method for controlling an optical modulator for an image display device that displays an image on an image display surface by scanning a combined light of a plurality of colored laser beams pixel by pixel at a predetermined time step, the method comprising the steps of:
using an optical modulator including a plurality of Mach-Zehnder optical modulation units, a power supply for applying a pixel voltage to each of the plurality of Mach-Zehnder optical modulation units independently, and a control unit that is configured to control the power supply and includes an integrating circuit capable of calculating an integrated value of the pixel voltages applied to each of the plurality of Mach-Zehnder optical modulation units,
controlling the power supply by the controlling unit, so as to continuously apply the pixel voltage at a predetermined applied voltage width to each of the plurality of Mach-Zehnder optical modulation units independently, and to further control the power supply to apply a shift voltage that is an even multiple of a half-wavelength voltage to each of the plurality of Mach-Zehnder optical modulation units at a timing when an integrated value of the pixel voltage integrated by the integrating circuit reaches a predetermined value for any of the plurality of Mach-Zehnder optical modulation units.

12. A method for controlling an optical modulator for an image display device that displays an image on an image display surface by scanning a combined light of a plurality of colored laser beams pixel by pixel at a predetermined time step, the method comprising the steps of:
using an optical modulator including a plurality of Mach-Zehnder optical modulation units, a power supply for applying a pixel voltage to each of the plurality of Mach-Zehnder optical modulation units independently, and a control unit that is configured to control the power supply and includes an integrating circuit capable of calculating an integrated value of the pixel voltages applied to each of the plurality of Mach-Zehnder optical modulation units,
controlling the power supply by the controlling unit, so as to continuously apply the pixel voltage at a predetermined applied voltage width to each of the plurality of Mach-Zehnder optical modulation units independently, and to further control the power supply to apply a shift voltage that shifts an applied voltage width to a position symmetrical with respect to an extreme value of optical output in a modulation curve of each of the plurality of Mach-Zehnder optical modulation units to each of the plurality of Mach-Zehnder optical modulation units at a timing when an integrated value of the pixel voltage integrated by the integrating circuit reaches a predetermined value for any of the plurality of Mach-Zehnder optical modulation units.
